(19) United States
(12) Patent Application Publication
(10) Pub. No.: US 2015/0186102 A1
(43) Pub. Date: Jul. 2, 2015

(54) INFORMATION PROCESSING DEVICE, TERMINAL DEVICE, AND IMAGE TRANSMISSION MANAGEMENT METHOD

(71) Applicant: FUJITSU LIMITED, Kawasaki-shi (JP)

(72) Inventors: Takashi YAMAGUCHI, Yokohama (JP); Kazushi YODA, Kawasaki (JP); Toshifumi MASUKO, Kawasaki (JP); Lingyan FENG, Yokohama (JP)

(21) Appl. No.: 14/643,592

(22) Filed: Mar. 10, 2015

Related U.S. Application Data
(63) Continuation of application No. PCT/JP2012/074447, filed on Sep. 24, 2012.

(51) Int. Cl. G06F 3/14

(52) U.S. Cl. CPC G06F 3/1462; G06F 3/1415

(57) ABSTRACT

An information processing device includes a communication unit that enables a communication via a network, and a control unit that executes a process including obtaining image data of an image having a content that is updated, obtaining timing information that identifies a transmission timing of the image data from a terminal device, which is a transmission destination of the obtained image data, and managing a transmission of the image data using the communication unit on the basis of the obtained timing information.

### CROSS-REFERENCE TO RELATED APPLICATION

This application is a continuation application of International Application PCT/JP2012/074447 filed on Sep. 24, 2012 and designated the U.S., the entire contents of which are incorporated herein by reference.

### FIELD

The embodiment discussed herein is related to a technique for transmitting and receiving image data by using a network.

### BACKGROUND

Currently, various types of data are transmitted and received via a network. One type of the various types of data is image data. Images displayed based on image data are broadly classified into a type having a display content of a fixed type, and a type having a display content that is updated when needed. Unless otherwise noted, an image is hereinafter used to indicate the type having the display content that is updated when needed.

Image data is normally transmitted to display an image. For an image having a display content that is updated when needed, it is demanded to continuously transmit image data of the image. When the image data is transmitted, a receiving side of the image data needs to process the received image data. Therefore, a load is imposed on both a transmitting side and a receiving side in order to transmit and process the image data, leading to an increase in the traffic volume of a network.

Thus, some conventional information processing devices used to transmit image data transmit image data for displaying an image after being updated only when the image is updated. By transmitting image data at the time of an update of an image, the number of times that the image data is transmitted per unit time, namely, a transmission frequency can be reduced. On the receiving side, a problem such that an update interval of an image becomes abnormally long does not occur. Accordingly, loads imposed on both the transmitting side and the receiving side can be reduced in a suitable form.

In an information processing device (hereinafter referred to as a “terminal device”), which is a reception destination of image data, received image data is drawn in a window. Normally, a terminal device can handle a plurality of windows, and a user can arbitrarily change a window to be actually displayed. Moreover, the user can arbitrarily change an above-behind relationship in a display of a plurality of windows, and between a display and a non-display of each of the windows.

In a window set to a non-display, an image drawn in the window is not made visible. This is the same also for a window on which another window positioned above overlaps entirely.

Neither the transmitting side nor the receiving side of image data always have a sufficient load tolerance in terms of a transmission and a reception of image data. It is desirable to further reduce the traffic volume of a network. In consideration of these factors, it is preferable to reduce a transmission frequency of image data within a range that does not cause a problem on the receiving side.

Patent Document 1: Japanese Laid-open Patent Publication No. 2011-70587

Patent Document 2: Japanese Laid-open Patent Publication No. 2004-213418

### SUMMARY

An information processing device includes a communication unit that enables a communication via a network; and a control unit that executes a process including: obtaining image data of an image having a content that is updated, obtaining timing information that identifies a transmission timing of the image data from a terminal device, which is a transmission destination of the obtained image data, and managing a transmission of the image data using the communication unit on the basis of the obtained timing information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration example of an information processing system to which an information processing device and terminal devices according to an embodiment are applied.

FIG. 2 is an explanatory diagram of a service rendered by a server.

FIG. 3 is an explanatory diagram of a display example of an image using image data transmitted from the server.

FIG. 4 is an explanatory diagram of an example of a mechanism for handling screen update interval information prepared in the server.

FIG. 5 is an explanatory diagram of an example of an update timing of an image set according to screen update interval information.

FIG. 6 is a flowchart illustrating a screen update interval information transmission process.

FIG. 7 is a flowchart illustrating a keyboard input information process.

FIG. 8 is a flowchart illustrating a save area output process.

FIG. 9 is a flowchart illustrating an image output process.

### DESCRIPTION OF EMBODIMENTS

In one aspect, an object of an embodiment is to provide a technique for further reducing a transmission frequency of image data while suppressing occurrence of problems on a receiving side.

An embodiment according to the present invention is described in detail below with reference to the drawings.

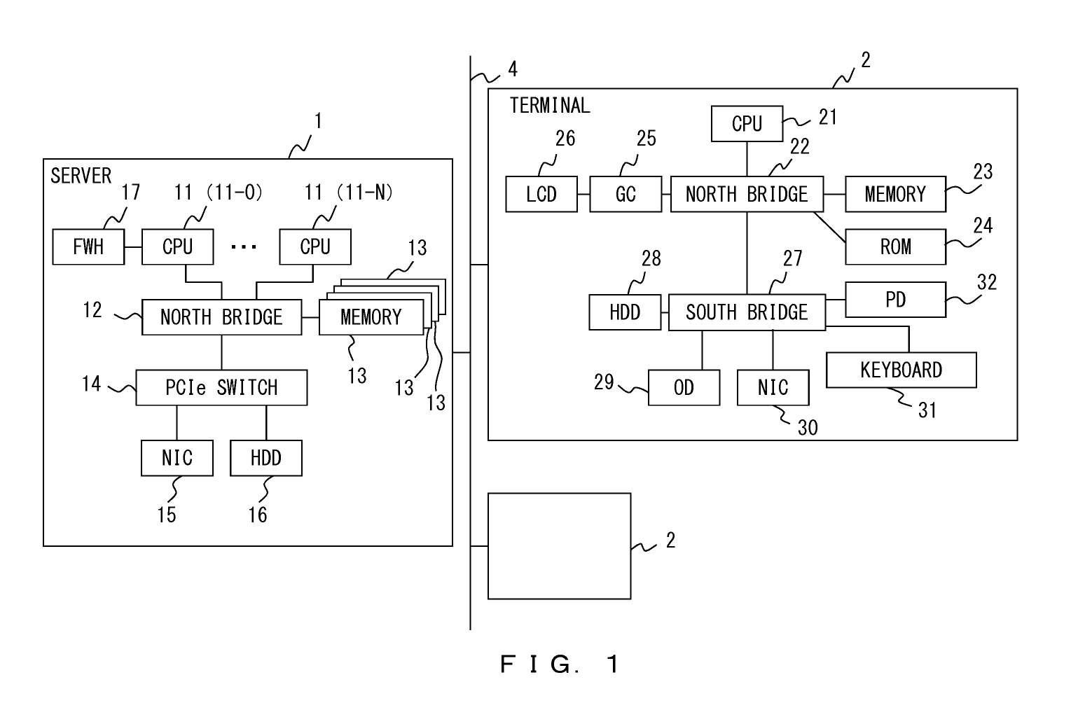

FIG. 1 illustrates a configuration example of an information processing system to which an information processing device and terminal devices according to the embodiment are applied.

The information processing system includes a configuration where a server 1 and a plurality of terminal devices 2 are connected to a network 4. The information processing device according to this embodiment is implemented as the server 1, whereas all the plurality of terminal devices 2 are terminal devices according to this embodiment.

The server 1 is an information processing device that executes a process requested by the terminal device 2 and transmits a result of the process to the terminal device when needed. The server 1 includes a plurality of CPUs (Central Processing Units 11-0 to 11-N), a north bridge 12, a plurality of memories 13, a PCIe (Peripheral Components Interconnect Express) switch 14, a NIC (Network Interface Card) 15, a hard disk drive (HDD) device 16, and an FWH (Firmware Hub) 17. The configuration of the server 2 illustrated in FIG. 1 is merely one example, and is not limited to this one.

Each of the CPUs 11 (11-0 to 11-N) is a computing unit that executes a program read into the memory 13. In the FWH 17 connected to one of the CPUs 11, a BIOS (Basic Input/Output System) executed by each of the CPUs 11 is stored. The CPUs 11 are interconnected, and the CPUs 11 to which the FWH 17 is not connected obtain the BIOS stored in the FWH 17 by communicating with the corresponding CPU 11, although this is not particularly illustrated.

The CPUs 11 and the memories 13 are connected to the north bridge 12. The north bridge 12 provides a function of enabling each of the CPUs 11 to access the memory 13 and of connecting each of the CPUs 11 to the PCIe switch 14.

The NIC 15 is a communication device that enables a communication made via a network 4. The hard disk drive device 16 is a storage device for storing a program that each of the CPUs 11 executes other than the BIOS, and various types of data.

The PCIe switch 14 is an input/output control device including various types of controllers. In this embodiment, the NIC 15 and the hard disk drive device 16 are connected to the PCIe switch 14. As a result, each of the CPUs 11 can control the NIC 15 and the hard disk drive device 16 via the north bridge 12 and the PCIe switch 14.

In the meantime, each of the terminal devices 2 includes a CPU 21, a north bridge 22, a memory 23, a ROM (Read Only Memory) 24, a GC (Graphics Controller) 25, an LCD (Liquid Crystal Display) 26, a south bridge 27, a hard disk drive device 28, an OD (Optical Drive) 29, a NIC 30, a keyboard 31, and a PD (Pointing Device) 32 as illustrated in FIG. 1. Similarly to the server 1, the configuration of the terminal device 2 illustrated in FIG. 1 is merely one example, and not limited to this one. For example, all the LCD 26, the OD 29, the keyboard 31 and the PD 32 may be included in the terminal device 2. However, these components may be connected to the terminal device 2.

In the above described configuration, the BIOS is stored in the ROM 24, and an OS (Operating System) and various types of application programs (hereinafter abbreviated to applications) are stored in the hard disk drive device 28. The CPU 21 reads the BIOS from the ROM 24 into the memory 23 via the north bridge 22 at startup, and executes the BIOS. Thereafter, the CPU 21 reads the OS from the hard disk drive device 28 into the memory 23 via the north bridge 22 and the south bridge 27, and executes the OS according to a control of the BIOS.

The GC 25 connected to the north bridge 22 is a display control device that makes an image visible on the LCD 26. The CPU 21 makes the image visible on the LCD 26 by creating image data of the image to be displayed with the use of the memory 23, and by transmitting the created image data to the GC 25.

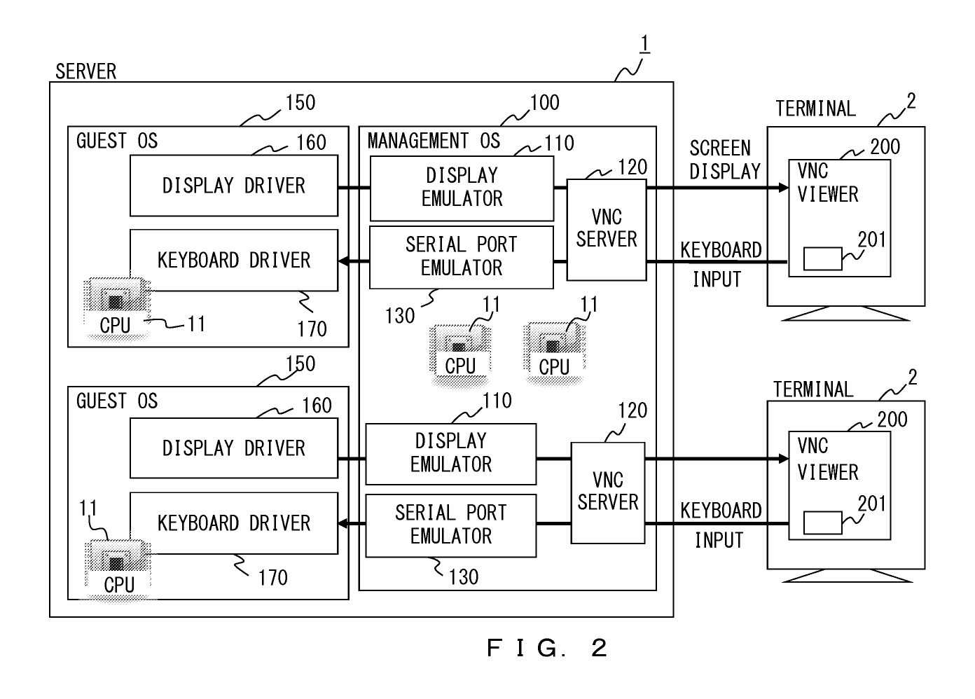

The south bridge 27 is an input/output control device including various types of controllers. In the configuration illustrated in FIG. 2, the hard disk drive device 28, the OD 29, the NIC 30, the keyboard 31 and the PD 32 are connected. These hardware resources are controlled by the CPU 21 via the north bridge 22 and the south bridge 27.

FIG. 2 is an explanatory diagram of a service rendered by the server.

In the server 1 having the configuration illustrated in FIG. 1, a plurality of VMs (Virtual Machines) are created. Each of guest OSes 150 illustrated in FIG. 2 is an OS executed by the created VM. A management OS 100 is an OS that manages the guest OSes 150 in the created VMs.

The management OS 100 and each of the guest OSes 150 run on a virtual machine monitor although this is not particularly illustrated. The management OS 100 includes various types of device drivers for accessing the hardware resources. A notification of a request issued from the guest OS 150 is made to the management OS 100 via the virtual machine monitor. Thus, the management OS 100 accesses a hardware resource to be accessed in response to the request issued from the guest OS 150. As a result, each of the VMs can communicate with the terminal device 2 via the network 4 with the process of the management OS 100. In FIG. 2, the guest OSes 150 and the management OS 100 are linked with lines and a virtual machine monitor is omitted for ease of understanding of a relationship between the management OS 100 and the guest OS 150 to which the management OS 100 issues a process request.

In each of the guest OSes 150, a display driver 160 and a keyboard driver 170 are represented as examples of installed software. In the management OS 100, a display emulator 110, a VNC (Virtual Network Computing) server 120, and a serial port emulator 130 are represented as examples of installed software.

A VM in which the guest OS 150 is executed renders a service for transmitting image data to the terminal device 2 as a result of the requested process. The image data is generated by the local guest OS 150, or an application that runs on the guest OS and is not illustrated. Here, the image data is assumed to be generated by an application for the sake of convenience. In FIG. 2, an image is represented as a “screen”.

The display driver 160 of the guest OS 150 is software for outputting the image data generated by the application. The keyboard driver 170 is software for supporting an operation performed on the keyboard 31 of the terminal device 2 that is connected to the server 1. Here, the application is assumed to generate image data of an image having a display content that is updated when needed.

The VNC server 120 included in the management OS 100 is software that enables a remote operation performed by the connected terminal device 2. The display emulator 110 converts image data output from the display driver 160 of the guest OS 150 into image data handled by the VNC server 120, and outputs the image data after being converted to the VNC server 120 via the VNC server 120.

The serial port emulator 130 receives, from the VNC server 120, data that represents content of an operation performed by the terminal device 2, processes the data, and converts the data, for example, into data that represents a key regarded as being operated on the keyboard 31. The keyboard driver 170 on the guest OS 150 receives the data after being converted by the serial port emulator 130, and notifies the guest OS 150 of the content of the operation performed on the terminal device 2. With this notification, the guest OS reflects the operation performed on the terminal device 2 on the process.

In the terminal device 2, a VNC viewer 200 is executed so that the operation for the keyboard 31 or the like can be reflected on the process of the guest OS 150. The VNC viewer 200 can display the image data received from the server 1 on the LCD 26, and can transmit the data that represents the content of the operation performed by the user to the keyboard 31 or the like. Accordingly, a user of the terminal device 2 can transmit desired image data to the server 1.

The CPU 11 is allocated to each of the above described guest OSes 150 and management OS 100, namely, each of the VMs. Thus, the CPU 11 allocated to each of the VMs is additionally illustrated. The number of the CPUs 11 allocated to the VMs is merely one example, and how to allocate the CPUs 11 is not particularly limited.

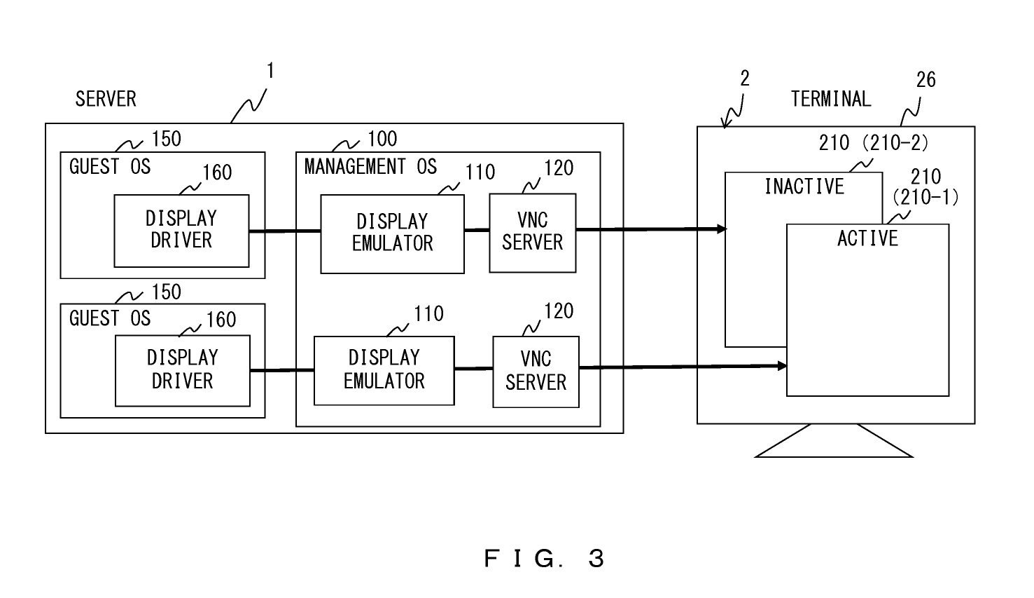

FIG. 3 is an explanatory diagram of a display example of an image using image data transmitted from the server. Each of the VMs in which the guest OS 150 is executed can transmit at least one type of image data. The image data transmitted from the server 1 by using VMs are displayed in different windows on the terminal device 2. FIG. 3 illustrates a state where the terminal device 2 displays the image data transmitted by two VMs in the server 1 on two windows 210 (210-1, 210-2).

When the plurality of windows 210 are displayed, an above-behind relationship among the windows 210 is set. A window 210 above which another window 210 is not positioned is referred to as being in an active state. In contrast, a window 210 above which another window 210 is positioned is referred to as being in an inactive state. Each of the windows 210 can be switched between a display and a non-display. Both the active state and the inactive state are sub-states that belong to the display state. When a plurality of windows 210 above which no windows 210 are positioned are present, only one of the windows 210 is placed in an active state. An operation performed in the window 210 is valid only for the window 210 placed in the active state.

At least part of the window 210 placed in the inactive state is not visible because another window placed in the active state overlaps. Presumably, there is a low probability that a user of the terminal device 2 places importance on an image within the window 201 at least part of which is invisible. In other words, it can be said that the image within the window 210 placed in the active state is assigned a higher priority than that in the window 210 placed in the inactive state for the user of the terminal device 2. In the window 210 placed in the non-display state, an image displayed in that window 210 is invisible. Thus, in this embodiment, the update timing of an image is controlled for each image (window 210) to be displayed in the terminal device 2.

The update timing of an image is controlled by setting an update interval of the image that is expected to have a less necessity for an update to be longer. The image data is transmitted at the set update interval. Accordingly, even if all the update intervals of images generated respectively by the VMs are equal, the number of times that image data is transmitted from the server 1 per unit time, namely, a transmission frequency depends on a display state of an image displayed based on image data in addition to the number of terminal devices 2 to which the image data is transmitted.

In the terminal device 2 that receives plural types of image data, there are not many cases where all the windows 210 in which an image is displayed based on the received image data are in the active state. For example, even in the terminal device 2 that receives one type of image data, the window 210 in which an image is displayed based on the image data is not always in the active state. This is because there is a probability that the window 210 displayed by a certain application is placed in the active state and the window 210 in which the image is positioned is placed in the inactive state. Thus, the transmission frequency of image data in the server 1 can be suppressed according to a control of the update timing of an image.

When the transmission frequency of image data in the server 1 is suppressed as described above, also the volume of traffic in the network 4 is reduced. Moreover, in the terminal device 2 that makes an image visible in the window 210 placed in the non-display state or the inactive state by using the transmitted image data, a reception frequency, which is the number of times that image data is received per unit time, becomes low. This means that the processing amount for handling the reception of image data is reduced and a load is lightened. Thus, performances demanded for the network 4 and/or the terminal devices 2 can be suppressed. As a result, also the information processing device can be configured at less cost.

The user of the terminal device 2 cannot view an image of the window 210 placed in the non-display state. There is a high probability that even if a large part of the image in the window 210 placed in the inactive state is visible, the image is not comparatively watched due to an existence of an image assigned a higher priority for the user of the terminal device 2. When the image is not watched, the degree of awareness is low even though the large part of the image is visible. Therefore, it is difficult to notice a change in the display content of the image. Thus, as for the update timing of an image, an image in the window 210 placed in the non-display state is not updated, and image data in the window 210 placed in the inactive state is updated at predetermined time intervals. When an image is updated at such timing, a user of the terminal device 2 is not aware of a problem, or the degree of awareness is low even though the user is aware of the problem. An image in the window 210 placed in the active state is updated in real time. Accordingly, the user of the terminal device 2 is unaware of a problem in the image of the window 210 placed in the active state.

In this embodiment, states of the windows 210 are classified into the non-display state, the active state, and the inactive state. Hereinafter, these states are generically referred to as “display setting states”. Such a classification of display setting states is merely one example, and the classification is not limited to the above described one. For example, a window 210 that is completely invisible among windows 210 placed in the inactive state is the same as that placed in the non-display state in fact. Thus, the non-display state may be handled as one type of the inactive state.

The server 1 itself cannot recognize a display setting state of the window 210 in which image data is displayed in the terminal device 2. Accordingly, in this embodiment, information that represents the display setting state of the window 210 in which image data is displayed is transmitted from the terminal device 2 to the server 1. The information transmitted to the server 1 is hereinafter referred to as “screen update interval information”.

To enable a transmission of the screen update interval information, in this embodiment, the terminal device 2 is caused to execute the VNC viewer 200 in which the screen update interval setting program 201 illustrated in FIG. 2 is embedded. The screen update interval setting program 201 identifies the display setting state of each window 210 in which an image is displayed by the VNC viewer 200, converts a result of the identification into a combination of keys on the keyboard 31, and transmits a result of the conversion as screen update interval information. The screen update interval information is transmitted, for example, each time a specified amount of time elapses. Thus, the screen update interval setting program 201 enables the server 1 to transmit image data displayed within each window 201 at a transmission frequency according to the display setting state of the window.

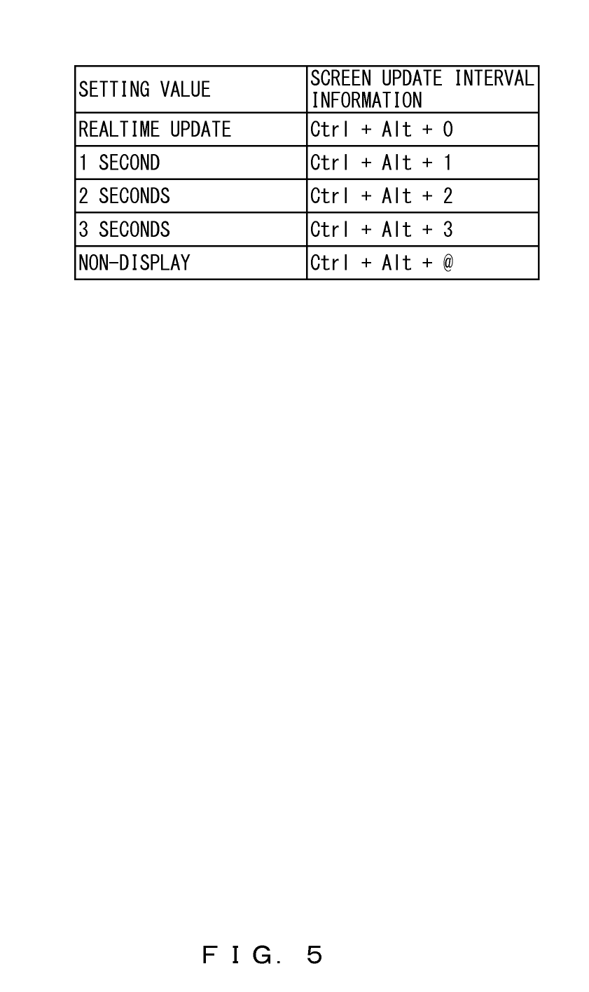

FIG. 5 is an explanatory diagram of an example of the update timing, set according to screen update interval information, of an image.

In FIG. 5, names of two items such as a “setting value” and “screen update interval information” are represented as item names. The item “setting value” corresponds to a set update timing of an image. In this embodiment, the update timing is assumed to be an update interval of an image, namely, a transmission interval at which image data for updating a display content of the image is transmitted.

The item “setting value” represents a “realtime update”, “1 second”, “2 seconds”, “3 seconds”, and a “non-display” as content of data. The “realtime update” means that an update of an image is reflected in real time. Thus, the “realtime update” represents that the active state is identified as the display setting state of the window 210. The “1 second”, the “2 seconds”, and the “3 seconds” mean that the update of the image is reflected every one to three seconds, and represent that the inactive state is identified as the display setting state of the window 210. The “non-display” means that the update of the image is not reflected, and represents that the non-display state is identified as the display setting state of the window 210.

The item “screen update interval information” represents “Ctrl+Alt+0” to “Ctrl+Alt+@” as content of data. For example, “Ctrl+Alt+0” represents a combination of a “Ctrl” key, an “Alt” key, and a “0” key. Other combinations are similarly represented.

For example, in the screen update interval setting program 201, data (hereinafter referred to as “update interval identification definition data”) that represents a correspondence between the display setting state of the window 210 and screen update interval information to be transmitted in the display setting state is defined as illustrated in FIG. 5. Thus, the screen update interval notification program 171 identifies, for each window 210, the screen update interval information to be transmitted by referencing the screen update interval identification definition data with the use of the display setting state of the window 210.

The server 1 sets the update timing of an image according to the screen update interval information received from the terminal device 2. As a result, the screen update interval information is used as information for directly designating the update timing of the image. This is because a user of the terminal device 2 is enabled to arbitrarily designate the update timing of the image in a window 210 placed in the inactive state as 1 to 3 seconds. When the user can arbitrarily change the update interval of the image in the window 210 placed in the inactive state, the image of the window 210 placed in the inactive state cannot be updated at an update interval desired by the user only by identifying the display setting state of the window 210.

Note that the screen update interval information for designating the update interval of the image in the window 210 placed in the inactive state may be automatically decided according to a ratio of a portion visible within the entire window 210. When the update interval of an image is made changeable among three steps of 1 to 3 seconds, a value range (such as 0 to 1) of the ratio of a visible portion is partitioned into three, a correspondence between each of the partitioned value ranges and each piece of screen update interval information may be set, and screen update interval information made to correspond to an actually obtained ratio may be selected. When the number of update intervals, settable for each display setting state, of the image is set to 1, a notification of the verified display setting state may be made to the server 1.

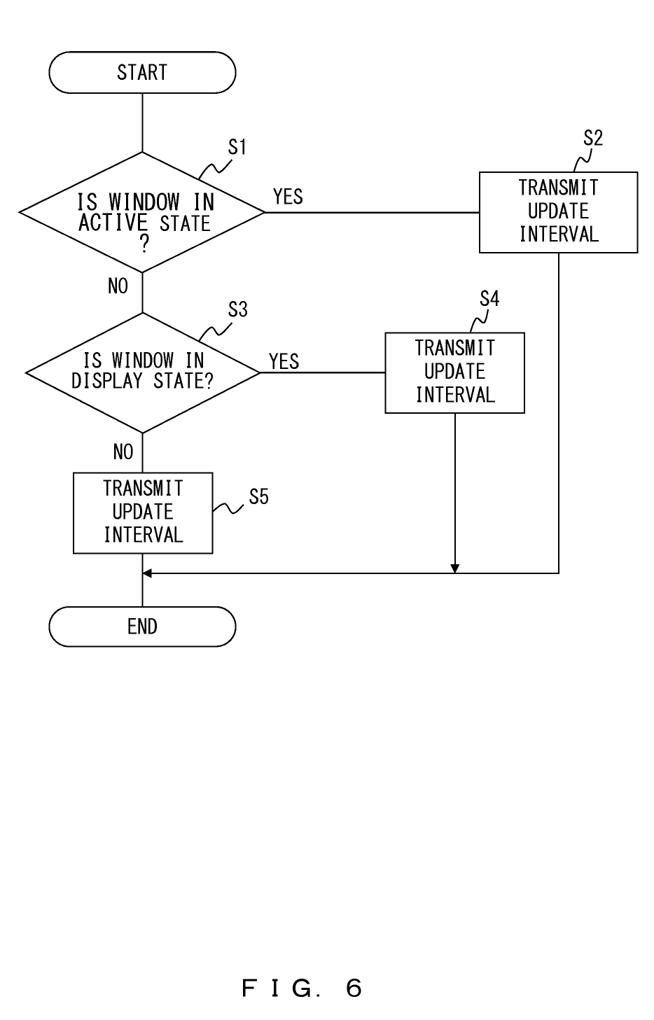

FIG. 6 is a flowchart illustrating a screen update interval information transmission process. The screen update interval information transmission process illustrated in FIG. 6 is a process implemented in a way such that the CPU 21 executes the screen update interval setting program 201 of the VNC viewer 200. When the image is displayed in a window 210 by the VNC viewer 200, the screen update interval information transmission process is executed each time a specified amount of time elapses as described above. For the sake of convenience, FIG. 6 illustrates a flow of the extracted process that is executed for one window 210 in which an image is displayed by the VNC viewer 200. Here, this screen update interval information transmission process is described in detail with reference to FIG. 6.

Initially, the CPU 21 determines whether a window 210 selected as a target is in the active state (S1). When the window 210 is in the active state, the determination of S1 results in “YES”. Next, the CPU 21 generates and transmits screen update interval information for issuing a request to update an image in real time (S2). The generated screen update interval information is transmitted in a way such that the CPU 21 outputs an IP address of the server 2 and a port number corresponding to an image displayed in the window 210 selected as the target to the NIC 30 along with the screen update interval information via the north bridge 22 and the south bridge 27. After the information is transmitted, the screen update interval information transmission process for one window 210 is terminated.

In contrast, when the window 210 selected as the target is not in the active state, the determination of S1 results in “NO”. In this case, the CPU 21 next determines whether the window 210 is in the display state (S3). When the window 210 is in the non-display state, the determination of S3 results in “NO”. Next, the CPU 21 generates screen update interval information for issuing a request of the non-display of the image, and transmits the information (S5). When the window 210 is in the display state, the determination of S3 results in “YES”. Next, the CPU 21 generates screen update interval information for issuing a request to update the image at intervals of one to three seconds, and transmits the information (S4). After the screen update interval information is transmitted in S4 or S5, the screen update interval information transmission process for one window 210 is terminated. When the determination of S3 results in “YES”, this means that the window 210 selected as the target is in the inactive state.

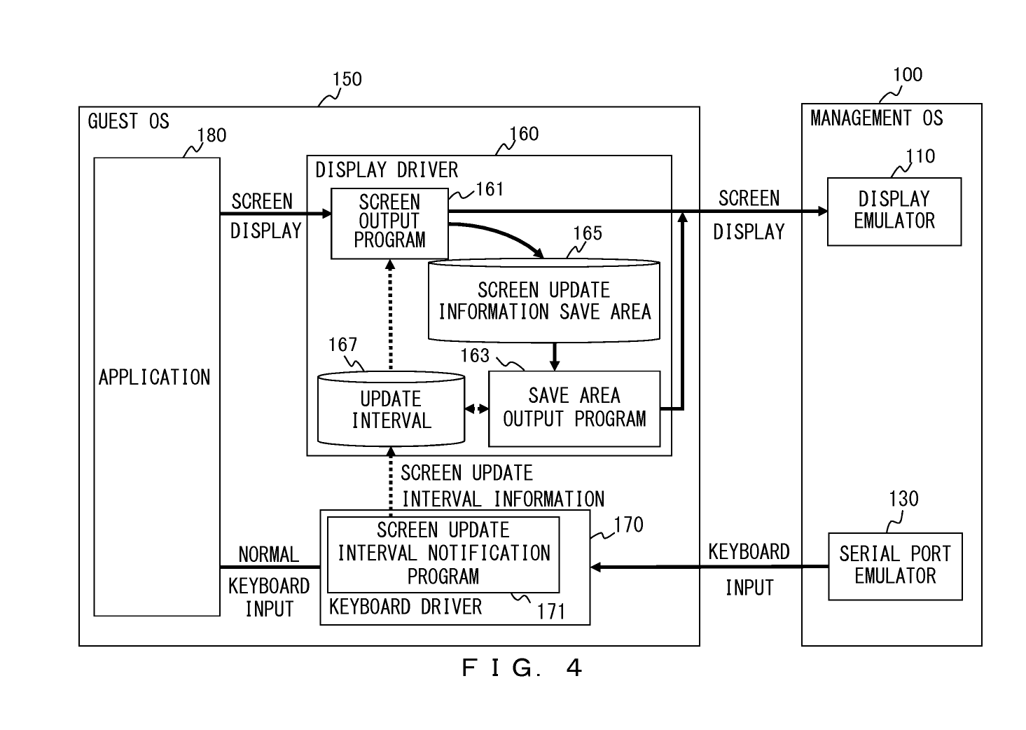

FIG. 4 is an explanatory diagram of an example of a mechanism for handling the screen update interval information prepared in the server.

As illustrated in FIG. 2, when the server 1 receives the screen update interval information transmitted from the terminal device 2, the information is processed by the VNC server 120. This screen update interval information is information that represents content of an operation (represented as a “keyboard input” in FIGS. 2 and 4) that a user performs for a key on the keyboard 31. Accordingly, the VNC server 120 passes the screen update interval information to the serial port emulator 130. Hereinafter, the information that represents the content of an operation that a user performs for a key on the keyboard 31 is generically called “keyboard input information”.

When the terminal device 2 transmits the screen update interval information, a port number assigned to a VM that generates image data is used in addition to an IP (Internet Protocol) address and a MAC (Media Access Control) address of the server 1 that transmits the image data. This port number is passed to the serial port emulator 130 along with the screen update interval information. As a result, the screen update interval information is passed, via a virtual machine monitor, from the serial port emulator 130 to the guest OS 150 of the VM that generates the image data.

The screen update interval information passed to the guest OS 150 is processed by the keyboard driver 170 because this information is keyboard input information. In the keyboard driver 170, the screen update interval notification program 171 is embedded. The screen update interval notification program 171 is a program that extracts the screen update interval information from the keyboard input information, and sets a screen update interval, which is an interval for transmitting image data, according to the extracted screen update interval information.

In the screen update interval notification program 171, data (hereinafter referred to as “update interval setting definition data”) for setting a transmission interval to be set according to the screen update interval information is defined as illustrated in FIG. 5. Thus, the screen update interval notification program 171 references the update interval setting definition data, determines whether the keyboard input information is screen update interval information, and identifies an update interval to be set when it is determined that the keyboard input information is the screen update interval information. The update interval data that represents the identified update interval is stored in an update interval storage area 167. The keyboard input information that is not identified as the screen update interval information is passed to the application 180 that generates image data.

In the update interval storage area 167, storage time data that represents a time at which the update interval data is lastly updated, and screen output destination data that represents an output destination of image data are stored in addition to the update interval data. The storage time data is updated by the screen update interval notification program 171.

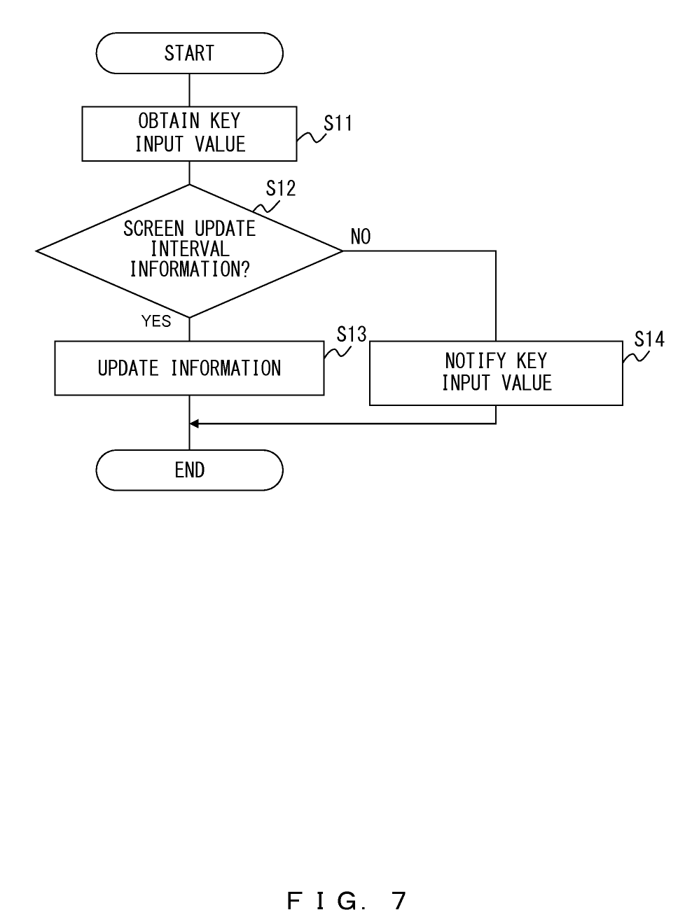

FIG. 7 is a flowchart illustrating the keyboard input information process. This keyboard input information process is a process implemented in a way such that at least one CPU 11 allocated to a VM in which the guest OS 150 is executed executes the keyboard driver 170. The keyboard driver 170 is executed by the guest OS 150 at timing when the keyboard input information is passed from the serial port emulator 130 of the management OS 100. Here, the keyboard input information process is described in detail with reference to FIG. 7.

Initially, the CPU 11 obtains the keyboard input information (represented as a “key input value” in FIG. 7) passed from the serial port emulator 130 of the management OS 100 (S11). Next, the CPU 11 determines, by using update interval setting definition data, whether the obtained keyboard input information is screen update interval information (S12). When the keyboard input information is one item of the screen update interval information illustrated in FIG. 5, the determination of S12 results in “YES”. In this case, the CPU 11 identifies an update interval designated by the screen update interval information with the use of the update interval setting definition data, and overwrites data of the update interval storage area 167 with the update interval data that represents the identified update interval. The CPU 11 updates the storage time data of the update interval storage area 167 to data that represents the current time (S13). After the update interval storage area 167 is updated in this way, the keyboard input information process is terminated.

When the obtained keyboard input information matches none of the screen update interval information illustrated in FIG. 5, the determination of S12 results in “NO”. In this case, the CPU 11 executes a process for notifying the application 180 of the obtained keyboard input information. Thereafter, the keyboard input information process is terminated.

In the keyboard input information process, when the screen update interval information is passed from the serial port emulator 130 as the keyboard input information, the update interval storage area 167 is updated based on the passed screen update interval information as described above. Thus, a change of the display setting state of the window 210 in the terminal device 2 can be handled. The screen update interval notification program 171 is used for the processes of the above described S12 and S13.

Returning to FIG. 4.

In FIG. 4, the update interval storage area 167 is represented within the display driver 160. An actual update interval storage area 167 is an array variable that can be updated by both the keyboard driver 170 and the display driver 160, or an area secured in a memory space allocated to a VM. The screen update information save area 165 represented within the display driver 160 is an area secured in the memory space allocated to the VM. Here, for the convenience of an explanation of the functions of the display driver 160, the update interval storage area 167 and the screen update information save area 165 are represented within the display driver 160.

The display driver 160 includes a screen output program 161 and a save area output program 163 as subprograms of the driver.

The screen output program 161 is a program for referencing screen output destination data stored in the update interval storage area 167, and for outputting the image data to an output destination designated by the screen output destination data. The output destination designated by the screen output destination data is the display emulator 110 of the management OS 100, or a screen update information save area 165. The screen update information save area 165 functions as a buffer for saving image data output from the application 180 while the transmission of the image data is being suspended.

The image data transmitted to display an image having a display content that is updated is normally data for one image or a difference from an immediately preceding image. The image data for one image may be obtained by simply overwriting image data within the screen update information save area 165 with image data output from the application 180. To obtain the difference of the image data, image data output from the application 180 needs to be reflected on the image data within the screen update information save area 165 while the transmission of the image data is being suspended. Thus, how to handle image data stored within the screen update information save area 165 differs depending on content of image data generated by the application 180. However, the content of image data generated by the application 180 is not particularly limited. Here, for the sake of convenience, the application 180 is assumed to output the difference of the image data from an immediately preceding image.

The save area output program 163 is a program for outputting image data stored in the screen update information save area 165. The save area output program 163 updates the screen output destination data stored in the update interval storage area 167. The reason why the save area output program 163 is caused to update the screen output destination data is to prevent image data to be transmitted later than image data yet to be transmitted from being transmitted in a situation where the image data yet to be transmitted is left in the screen update information save area 165.

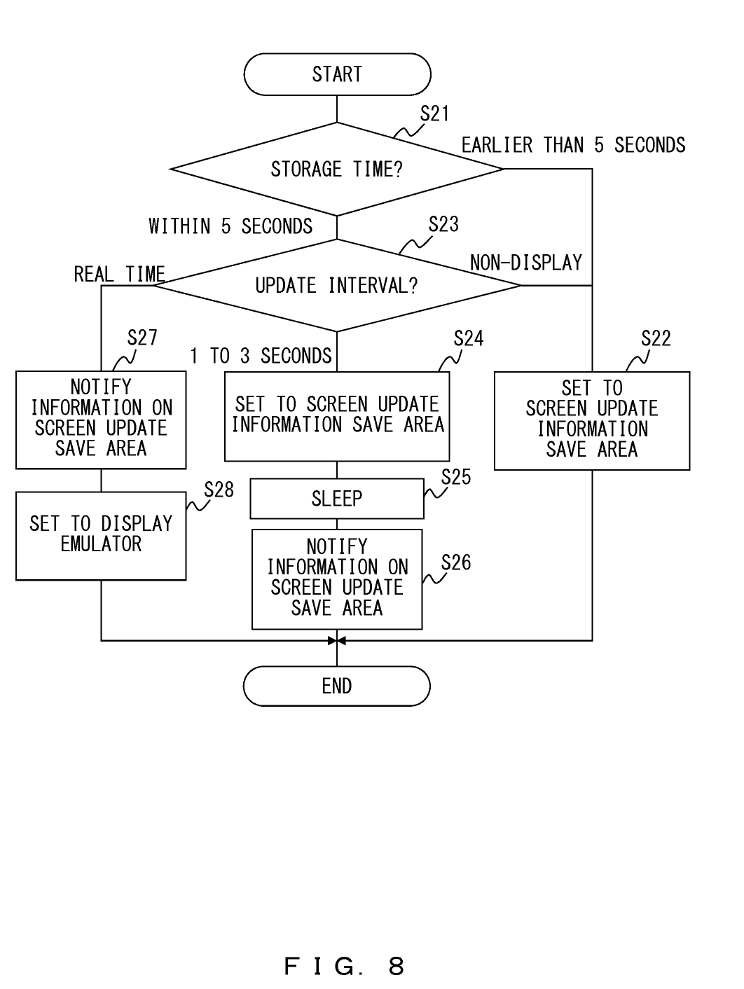

FIG. 8 is a flowchart illustrating the save area output process. This save area output process is a process for transmitting image data stored in the screen update information save area 165, and is implemented in a way such that at least one CPU 11 allocated to a VM in which the guest OS 150 is executed executes the save area output program 163. This save area output process is executed, for example, each time a specified length of time elapses, according to a control of the guest OS 150. Here, the save area output process is described in detail with reference to FIG. 8.

Image data generated by a VM is sometimes transmitted to a plurality of terminal devices 2. In this case, the update interval storage area 167 and the screen update information save area 165 are secured for each of the terminal devices 2. For the sake of convenience, FIG. 8 represents a flow of an extracted process that is executed for one terminal device 2.

Initially, the CPU 11 references storage time data in the update interval storage area 167, and determines a time at which update interval data is updated (S21). When the update time is earlier than the current time by 5 seconds or more, this is determined in S21. Next, the CPU 11 updates the output destination represented by the screen output destination data of the update interval storage area 167 to the screen update information save area 165. After this update, the save area output process is terminated. When the update time is within 5 seconds from the current time, this is determined in S21, and the flow proceeds to S23.

The terminal device 2, which is a transmission destination, cannot possibly process image data due to an occurrence of a problem. Even if a user terminates the VNC viewer 200, the terminal device 2 cannot process the image data. Thus, the determination of the above described S21 is made to determine whether the terminal device 2, which is the transmission destination, is in a state able to process the image data. Therefore, the terminal device 2 in which the length of time longer than 5 seconds elapses from the time when the screen update interval information is not transmitted anymore is regarded as being in a state unable to process the image data. Accordingly, the output destination represented by the screen output destination data is set to the screen update information save area 165 regardless of content of the update interval data in the update interval storage area 167, and a transmission of image data expected to be useless is stopped. The reason why the screen update interval setting program 201 embedded in the VNC viewer 200 that is executed by the terminal device 2 is caused to transmit the screen update interval information each time the specified length of time elapses is to enable a determination of whether the terminal device 2 is in the state able to process the image data.

In S23, the CPU 11 determines an update interval represented by the update interval data of the update interval storage area 167. When the update interval represented by the update interval data indicates a non-display, this is determined in S13, and the process of the above described S22 is executed. When the update interval represented by the update interval data indicates 1 to 3 seconds, this is determined in S13, and the flow proceeds to S24. When the update interval represented by the update interval data indicates real time, this is determined in S13, and the flow proceeds to S27.

In S24, the CPU 11 updates the output destination represented by the screen output destination data of the update interval storage area 167 to the screen update information save area 165. Next, when image data yet to be transmitted is left in the screen update information save area 165, the CPU 11 enters a sleep state (standby state) until the timing at which the image data is to be transmitted is reached (S25). The CPU 11 that quits the sleep state makes a notification for causing the display emulator 110 of the management OS 100 to process the image data stored in the screen update information save area 165 (S26). Thereafter, this save area output process is terminated.

In S27, the CPU 11 makes a notification for causing the display emulator 110 of the management OS 100 to process the image data yet to be transmitted that is stored in the screen update information save area 165 (S27). Next, the CPU 11 updates the output destination represented by the screen output destination data of the update interval storage area 167 to the display emulator 110 (S28). Thereafter, this save area output process is terminated.

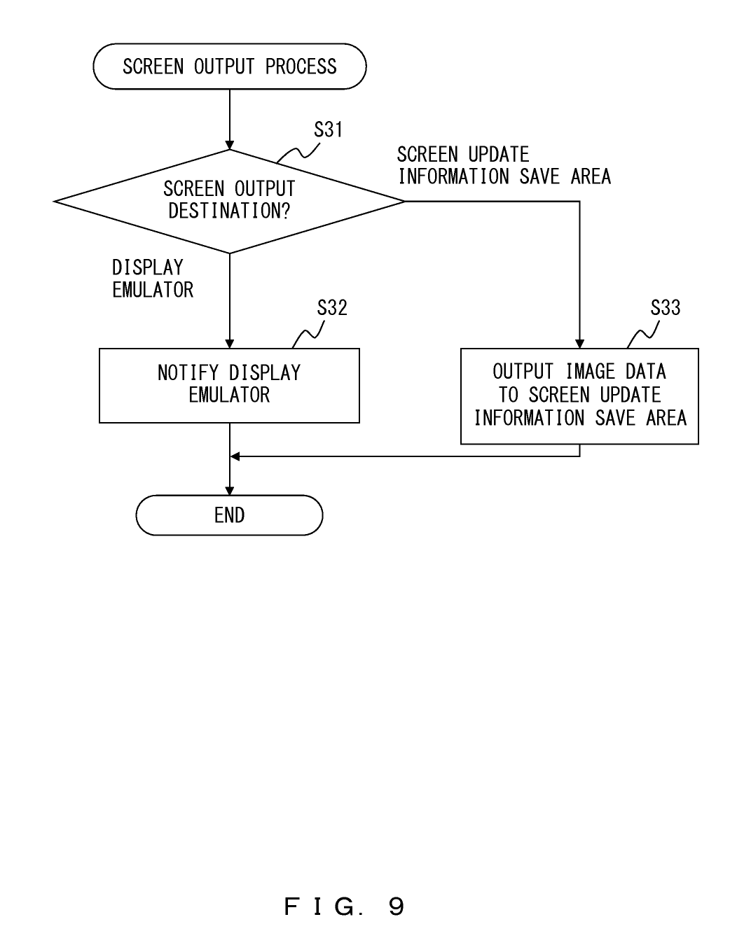

FIG. 9 is a flowchart illustrating the image output process. This image output process is a process for outputting image data output from the application 180 to an output destination, and is implemented in a way such that at least one CPU 11 allocated to a VM in which the guest OS 150 is executed executes the image output program 161. This image output process is executed at timing when image data is generated by the application 180, according to a control of the guest OS 150. The image output process is described in detail next with reference to FIG. 9.

Image data generated by a VM is sometimes transmitted to a plurality of terminal devices as described above. In this case, the update interval storage area 167 and the screen update information save area 165 are secured for each of the terminal devices 2. Thus, for the sake of convenience, FIG. 9 represents a flow of an extracted process that is executed for one terminal device 2 similarly to FIG. 8.

Initially, the CPU 11 references the screen output destination data of the update interval storage area 167, and determines an output destination represented by the screen output destination data (S31). When the output destination represented by the screen output destination data is the display emulator 110, this is determined in S31. Next, the CPU 11 makes a notification for causing the display emulator 110 of the management OS 100 to process the generated image data (S32). Thereafter, this screen output process is terminated.

Alternatively, when the output destination represented by the screen output destination data is the screen update information save area 165, this is determined in S31, and the flow proceeds to S33. In S33, the CPU 11 stores the generated image data in the screen update information save area 165. Thereafter, this screen output process is terminated.

In this embodiment, the guest OS 150 executed in a VM is provided with the functions (the screen output program 161 and the save area output program 163) for controlling a transmission interval of image data. However, another program may be provided with these functions. Alternatively, the application 180 or the management OS 100 may be provided with the functions. The reason why the guest OS 150 is provided with these functions in this embodiment is to bring advantages such that an application caused to run on the guest OS 150 is prevented from being modified and a load imposed on the management OS can be lightened. The functions may be distributed to a plurality of programs so that a program such as the screen output program 161 and a program such as the save area output program 163 are distributed respectively to the application 180 and the guest OS 150 (the display driver 160). Namely, the method of providing the functions is not particularly limited as long as a transmission interval of image data can be suitably managed.

With one system to which this embodiment is applied, a transmission frequency of image data can be further reduced while suppressing occurrences of problems on a receiving side.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a communication unit that enables a communication via a network; and
a control unit that executes a process including:
obtaining image data of an image having a content that is updated,
obtaining timing information that identifies a transmission timing of the image data from a terminal device, which is a transmission destination of the obtained image data, and
managing a transmission of the image data using the communication unit on the basis of the obtained timing information.

2. The information processing device according to claim 1, wherein
the timing information is information decided according to a display setting state of the image in the terminal device.

3. A terminal device comprising:
a communication unit that enables a communication via a network; and
a control unit that executes a process including:
displaying image data received by the communication unit on a display device,
identifying a display setting state of the image data for each piece of image data received by the communication unit,
generating, on the basis of the identified display setting state, timing information that designates a transmission timing of the image data; and
causing an information processing device, which is a transmission source of the image data, to transmit the generated timing information by using the communication unit.

4. A method for managing a transmission of image data via a network, the method comprising:
identifying, by using a receiving side device of the image data, a display setting state of the image data,
transmitting, by using the receiving side device, state information representing the identified display setting state to a transmitting side device of the image data; and
managing, by the transmitting side device, a transmission interval of the image data on the basis of the state information.

5. The method according to claim 4, the method further comprising:
continuously transmitting, by the receiving side device, the state information at a specified timing;
determining, by using the transmitting side device, whether the receiving side device can process the image data on the basis of a reception state of the state information; and
reflecting, by using the transmitting side device, a result of the determination on management of the transmission interval of the image data.
